(19) United States
(12) Patent Application Publication
(10) Pub. No.: US 2010/0085904 A1
(43) Pub. Date: Apr. 8, 2010

(54) POWER CONTROL SYSTEM IN RADIO COMMUNICATION

(75) Inventors: Osamu HAMAUE, Kawasaki (JP); Katsuaki Akama, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kanagawa (JP)

(21) Appl. No.: 12/636,532

(22) Filed: Dec. 11, 2009

Related U.S. Application Data
(63) Continuation of application No. PCT/JP07/00681, filed on Jun. 22, 2007.

(51) Int. Cl. G08C 17/00

(52) U.S. Cl. 370/311; 455/68

(57) ABSTRACT

A power control system for controlling power consumption of a mobile station used in a radio communication system. The power control system includes a prediction unit and an operation mode setting unit. The prediction unit is configured to predict an outside-communication-area-time taken for the mobile station to pass through a zone in which an intensity of a received radio wave from a base station detected in the mobile station is smaller than a specified value, on a basis of cell information indicating a location of the base station and a communication area, and movement history information indicating movement history of the mobile station. The operation mode setting unit is configured to set the mobile station to a low power consumption mode during the outside-communication-area-time obtained by the prediction unit.

### CROSS REFERENCE TO RELATED APPLICATIONS

This application is a continuation of PCT application PCT/JP2007/000681, which was filed on Jun. 22, 2007.

### FIELD

The embodiment discussed herein relates to power consumption control of a mobile station used in a radio communication system.

### BACKGROUND

Mobile stations such as a mobile phone station usually have an internal battery as a power supply, and it is important to extend the time of the operability at limited power. In particular, when communication means are limited to a mobile phone station or the like, it is crucial to avoid unnecessary power consumption and to extend the time of operability.

While the power supply of a mobile phone station is ON, the mobile phone station generally transmits/receives a radio signal to/from a mobile communication system. In other words, each base station regularly broadcasts a radio signal called an annunciation signal (or an advertisement), as illustrated in FIG. 1A. Once an annunciation signal is received, the mobile phone station transmits a response signal back to the base station that is the transmission source of the annunciation signal. Due to this response signal, the location of the mobile phone station is detected. Then, the mobile communication system registers the locations of each mobile phone station.

However, when the mobile phone station is located outside the communication area of the mobile communication system, the mobile phone station does not receive an annunciation signal from any base station. In such a case, the mobile phone station regularly transmits a base station search signal as illustrated in FIG. 1B. Therefore, the mobile phone station needlessly consumes power by repeatedly transmitting a base station search signal, in spite of the fact that it does not communicate with any base station.

A base station searching method in view of the above problem has been proposed (for example, Japanese Laid-open Patent Publication No. 2006-140912). According to this base station searching method, a radio communication mobile station measures a receiving level. When the receiving level gradually decreases, it is determined that the radio communication mobile station is moved outside the service area as the radio communication mobile station moves away from base stations. In this case, the radio communication mobile station extends the cycle of the base station search. Accordingly, the power consumption of the radio communication mobile station is controlled when the radio communication mobile station is outside the service area.

However, even according to this method, the mobile phone station still performs a base station search at a certain frequency in spite of the fact that there is no base station able to be communicated with around. Therefore, the mobile phone station needlessly consumes power when it is located outside the service area for a long time. Especially when it is in the mountains, in the forest, or at sea, it is likely that the mobile phone station will be located outside the service area for a long time as there are few or no base stations around. Accordingly, the power of an internal battery of the mobile phone station is needlessly consumed.

### SUMMARY

A power control system according to an aspect of the embodiment is the power control system for controlling power consumption of a mobile station used in a radio communication system, comprising a prediction unit configured to predict an outside-communication-area-time taken for the mobile station to pass through a zone in which an intensity of a received radio wave from a base station detected in the mobile station is smaller than a specified value, the prediction being done on the basis of cell information indicating a location of the base stations and a communication area, and on the basis of movement history information indicating movement history of the mobile station; and an operation mode setting unit configured to set the mobile station to a low power consumption mode during an outside-communication-area-time obtained by the prediction unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is a sequence diagram illustrating the operations performed by a mobile station located in the communication area.

FIG. 1B is a sequence diagram illustrating the operations performed by a mobile station located outside the communication area.

FIG. 2 is a diagram illustrating an overview of one aspect of the embodiment.

FIG. 3 is a diagram illustrating an exemplary mobile communication system according to one embodiment.

FIG. 4 is a diagram illustrating a configuration of a base station device according to an embodiment.

FIG. 5 is a diagram illustrating the estimation of which cells are destination cells.

FIG. 6 is a diagram illustrating a configuration of a mobile station according to an embodiment.

FIG. 7 is a diagram illustrating radio field intensity received in a mobile station.

FIG. 8 is a flow chart illustrating a predicting method of an outside-communication-area-time.

FIG. 9 is an embodiment of a cell information database.

FIG. 10 is an embodiment of a movement history information database.

FIG. 11 is an embodiment of a no radio wave zone information database.

FIG. 12 is an embodiment of a movement direction estimation table.

FIG. 13 is a diagram illustrating the sequences of controlling the electric power of a mobile station.

### DESCRIPTION OF EMBODIMENTS

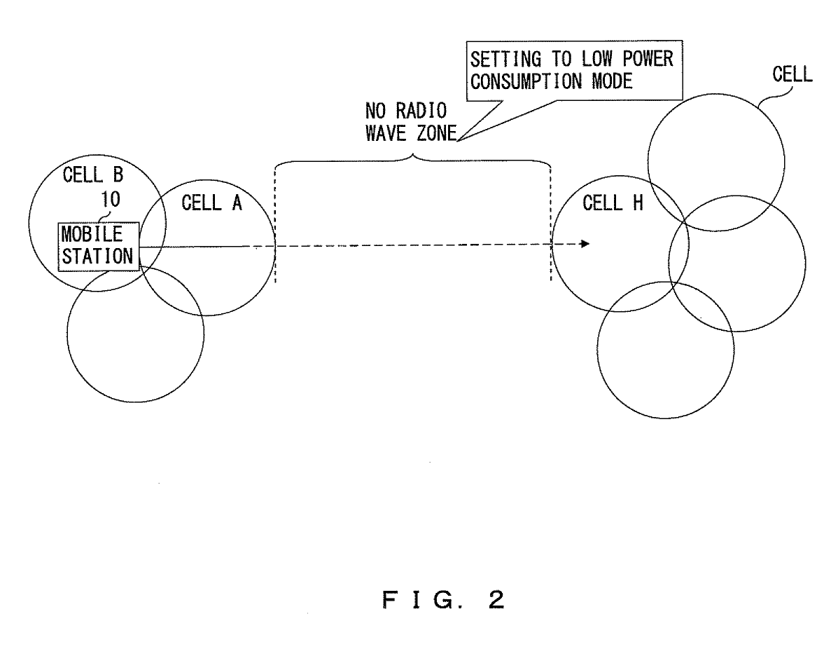

FIG. 2 is a diagram illustrating an overview of one aspect of the embodiment. As a mobile station 10 moves, the mobile station 10 may locate in a no radio wave zone where the mobile station 10 does not communicate with any base station. Here, the no radio wave zone means a zone where no signal from any base station reaches the mobile station or a zone where none of the signals that have reached the mobile station are at a sufficient intensity to be capable of communication. Expressions such as “outside the communication area”, “zone outside the communication area”, and “out-of-service communication area” also indicate a zone where none of the signals that have reached the mobile station are at the sufficient intensity to be capable of communication, and mean the same as no radio wave zone.

As described above, the mobile station 10 does not communicate with a base station while the mobile station 10 is located in a no radio wave zone. In other words, the mobile station 10 needlessly consumes power if it performs the base station search in a no radio wave zone while passing through a path such as is illustrated in FIG. 2. However, if the mobile station 10 is set to a low power consumption mode while existing in a no radio wave zone, power consumption under a non-communication condition can be saved. As a result, the operable time of the mobile station within the communication area can be extended.

In the low power consumption mode, for example, a part of the mobile station 10 is set to a sleep mode. By applying the low power consumption mode, sections related to a base station search may be set to a sleep mode in order to terminate a base station search during an outside-communication-area-time. Accordingly, the power consumption can be reduced because an unnecessary base station search can be avoided, and thereby the operable time of the mobile station can be extended.

Here, “outside-communication-area-time” means, for example, the predicted length of time for the mobile station to pass through the no radio wave zone. “Outside-communication-area-time” may also be defined as the estimated length of time during which the intensity of the radio wave transmitted from a base station is smaller than a specified value. This specified value is, for example, the smallest value of the radio field intensity that is capable of communication. Alternatively, upon dividing the radio field intensity into several levels, the outside-communication-area-time may be defined as the time that the level is smaller than a certain specified level.

In one embodiment, the “outside-communication-area-time” is predicted before the mobile station 10 moves from the communication area to the no radio wave zone. In FIG. 2, the time taken for the mobile station 10 to move from cell A to cell H is predicted when the mobile station 10 is in the cell A. Once the outside-communication-area-time information is obtained, the mobile station 10 shifts the operation mode from a normal operation mode to the low consumption mode in an autonomic manner. Subsequently, when the outside-communication-area-time has passed, the mobile station 10 shifts the operation mode from the low power consumption mode back to the normal operation mode. Assuming that the mobile station 10 is located in cell H at that time, the mobile station 10 can receive an annunciation signal from a base station of the cell H.

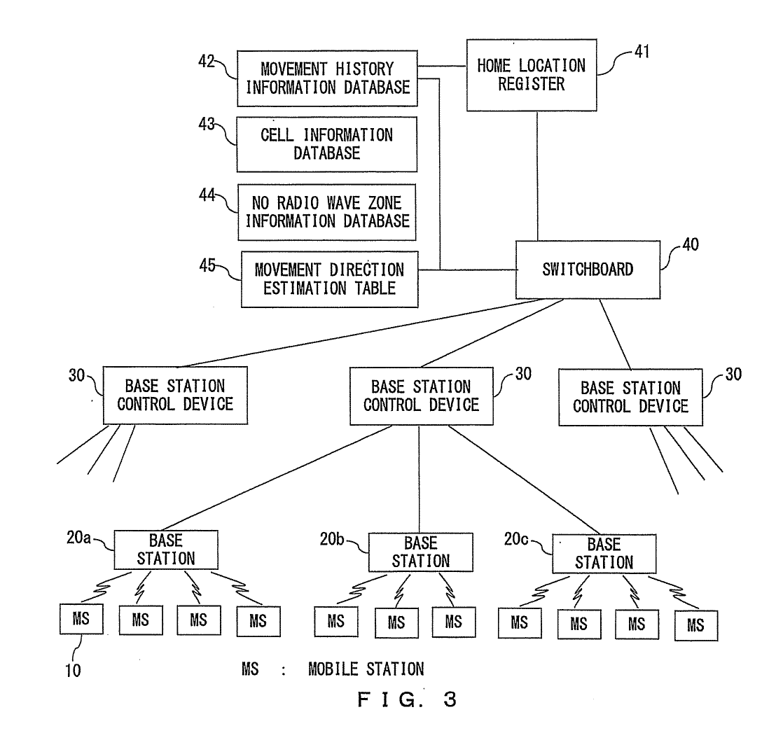

FIG. 3 is a diagram illustrating an exemplary mobile communication system according to one embodiment. In FIG. 3, two or more base stations 20 (20a-20c) are controlled by a base station control device 30. The two or more base station control devices 30 are connected to each other via a switchboard 40, and the switchboards 40 are connected to each other via a network called the core network.

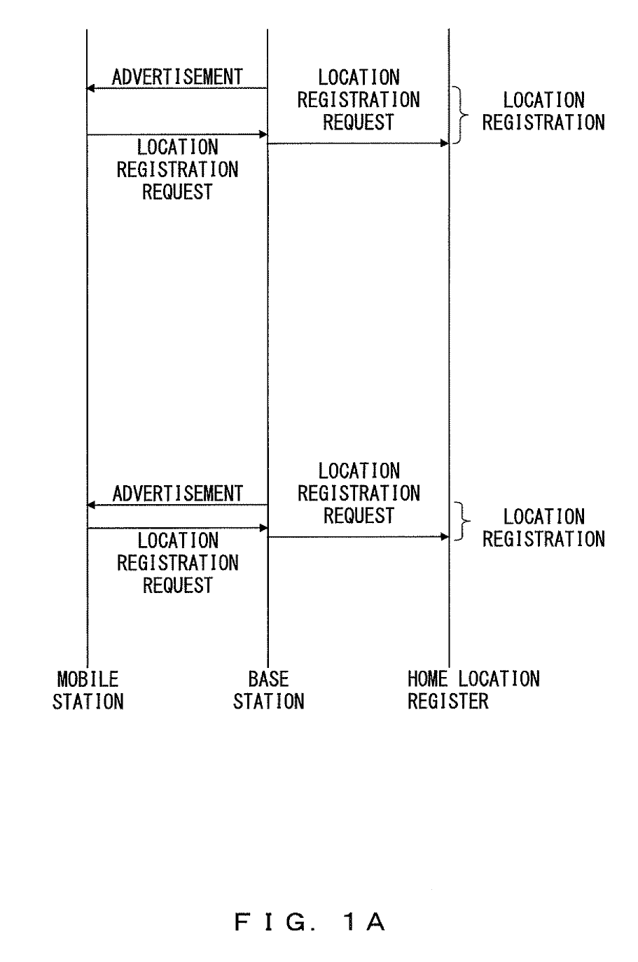

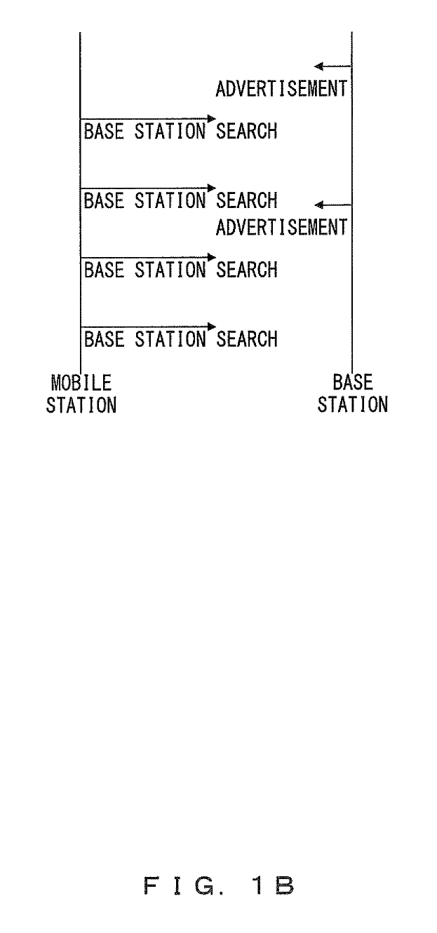

In FIG. 2, the base stations 20 configuring the cells A and B are respectively illustrated as base stations 20a and 20b. When the mobile station 10 is located in cell B, the mobile station 10 transmits a response signal including a location registration request to the base station 20b once an advertisement from the base station 20b is received, as illustrated in FIG. 1A. The location registration request is transmitted to the switchboard 40 via the base station 20b and the base station control device 30. The location registration request is further transmitted to a home location register 41 via the switchboard 40. The home location register 41 is a database that manages the location registration information of the mobile stations 10.

As the mobile station 10 moves to the cell A, a base station able to be communicated with is changed. The mobile station 10 transmits a location registration request in accordance with an advertisement from the base station 20a that has newly become a base station able to be communicated with. This location registration request is transferred to the switchboard 40 via the base station 20a, and the location of the mobile station 10 is registered in the home location register 41. When the location of the mobile station 10 is updated in the home location register 41, the history of the changes of location registration is recorded in a movement history information database 42.

In FIG. 3 and the following explanation, the same base station control device 30 and switchboard 40 control the cells from which the mobile station 10 moves and the cells to which the mobile station 10 moves; however, this is only for the purpose of simplification. In other words, the base station 20a configuring the cell A and the base station 20b configuring the cell B may be controlled by the different base station control devices 30 and switchboards 40. If the mobile station 10 moves between the base stations 20 that are controlled by different switchboards 40, the base station device 20 and/or the mobile station 10 is/are able to access the information recorded in the databases or tables via the core network.

When moving to the cell of base station 20a at an edge of the communication area, the mobile station 10 may go outside the communication area as indicated by dashed lines represented in FIG. 2 if the mobile station 10 continues moving. At this time, a power control system according to the embodiment predicts the length of time during which the mobile station 10 will be outside the communication area. The length of time during which the mobile station 10 will be outside the communication area is calculated on the basis of the locations of the base stations, the communication area, the moving path, and the moving time that are predicted for the mobile station 10, or the like. These kinds of data are stored in the movement history information database 42, a cell information database 43, a no radio wave zone information database 44, movement direction estimation table 45, or the like, or are calculated on the basis of the stored data. The outside-communication-area-time is predicted before the mobile station 10 actually moves out of the communication area.

Once the outside-communication-area-time is predicted, the mobile station 10 is set to the low power consumption mode for the predicted length of time. Unnecessary power consumption can be avoided due to this low power consumption mode setting.

### <Base Station Device>

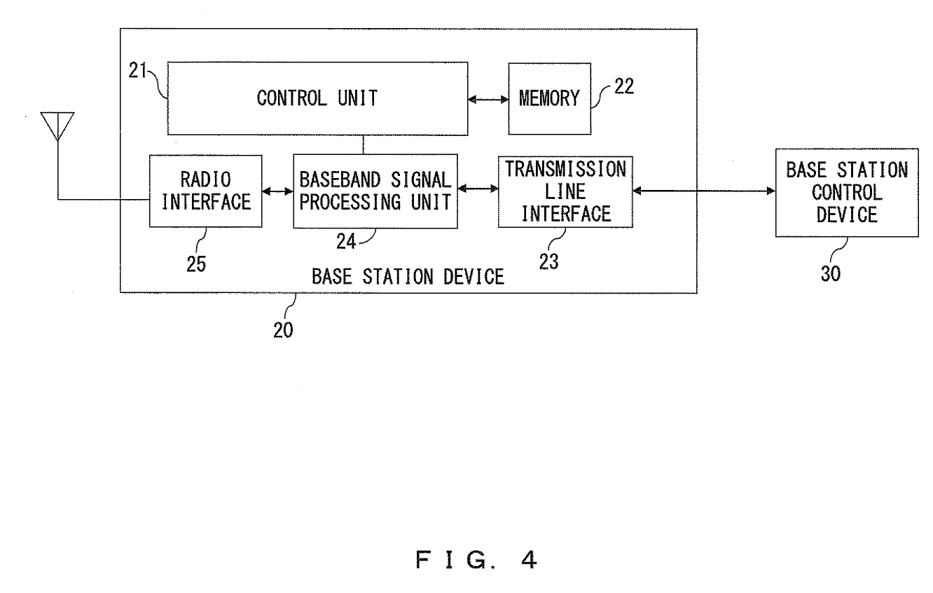

FIG. 4 illustrates a configuration of the base station device 20 according to one embodiment. The base station device 20 is comprised of a control unit 21, a memory 22, a transmission line interface 23, a base band signal processing unit 24, a radio interface unit 25, and an external antenna.

The transmission line interface 23 is a unit for the base station device 20 to communicate with the base station control device 30. The base station device 20 can access the switchboard 40, the movement history information database 42, the cell information database 43, the no radio wave zone information database 44, the movement direction estimation table 45 or the like, via the base station control device 30.

The radio interface 25 is a termination of the radio channel, and is for transmitting/receiving a signal to/from the mobile station 10. The baseband signal processing unit 24 is connected to the control unit 21, and processes in the baseband area the signal transmitted/received by the transmission line interface 23 or the signal transmitted/received by the radio interface 25.

The memory 22 includes, for example, a read-only memory (ROM) or a random access memory (RAM), and stores a program and data that are used in the processing. The control unit 21 provides a function of dealing with the operation of a base station by executing a program with the use of the memory 22. The control unit 21 may store the data that is used in common with several kinds of processing (for example, the base station where the mobile station is located, or the path through which the mobile station moved) in the memory 22, thereby improving the efficiency of the processing.

The base station device 20 according to the embodiment includes a speed estimation function and a direction estimation function for estimating the movement of the mobile station, and a prediction function for predicting the outside-communication-area-time of the mobile station. The speed estimation and direction estimation of the mobile station, and the prediction of the length of time during which the mobile station is located outside the communication area are carried out by the control unit 21 of the base station device 20. Specific methods for the speed estimation, the direction estimation, and the prediction of the length of time of being located outside the communication area will be described later. The speed estimation, the direction estimation, and the prediction of the length of time of being located outside the communication area may be carried out by the mobile station 10.

The base station device 20 may further include a notification function for notifying the mobile station 10 of the predicted length of time during which the mobile station is located outside the communication area. The base station device 20 will be configured to notify the mobile station 10 of the outside-communication-area-time before the mobile station 10 goes outside the communication area.

The base station device 20 may further include a destination cell estimation function. The destination cell estimation function is for estimating which cell is closest to the cell at which the mobile station is located among the cells located in the predicted movement direction of the mobile station. When estimating which cell is a destination cell, the cell information database 43 is accessed on the basis of the movement direction and the movement speed estimated about the mobile station. Here, the cell information database 43 is used for designating the location of the base station and the distance that the radio wave can be transmitted. Accordingly, if the location of a base station and the information corresponding to the distance that the radio wave can be transmitted are within the base station, the data in the base station may be used.

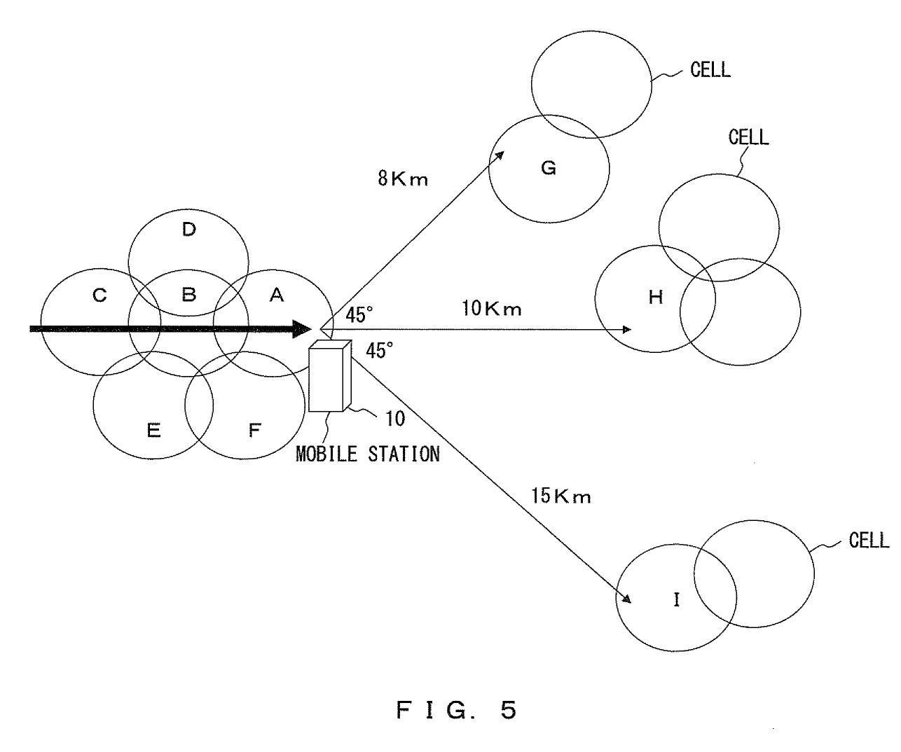

Moreover, the base station device 20 may further include a reachability estimation function for the destination cell which is obtained from the destination cell estimation function. The reachability estimation function is for estimating the possibility of reaching the cells that are estimated to be destination cells. The reachability estimation function estimates the possibility when two or more cells are obtained as cells that may be destination cells, as illustrated in FIG. 5. Specific methods of estimating the reachability will be described later. The destination cell estimation and the reachability estimation may be carried out by the mobile station 10.

If the base station device 20 is located at an edge of the communication area, the mobile station 10 may go outside the communication area when moving out from the cell of that base station. For this reason, the base station device 20 may include a notification function for notifying the mobile station 10 of the fact that the mobile station is in a base station at an edge of the communication area. It may be configured such that the power control system according to the embodiment is operated in response to the notification that the mobile station is in a base station at an edge of the communication area.

### <Mobile Station>

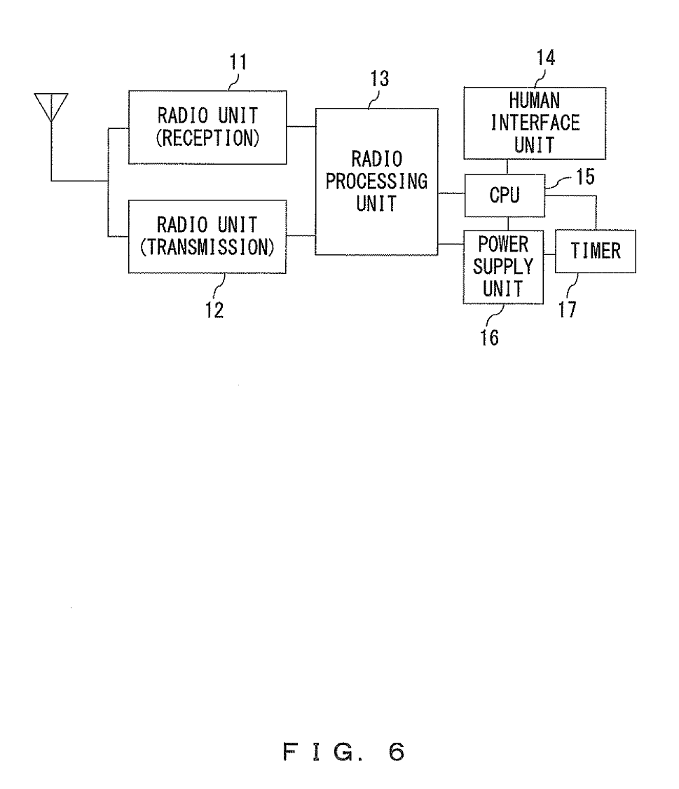

FIG. 6 illustrates a configuration of the mobile station 10 according to one embodiment. The mobile station 10 includes radio units 11 and 12, a radio processing unit 13, human interface unit 14, Central Processing Unit (CPU) 15, power supply unit 16, a timer 17, and an antenna unit.

The mobile station 10 transmits/receives a signal to/from a base station by using the radio units 11 and 12. The notification that a base station able to be communicated with is located at an edge of the communication area, the outside-communication-area-time predicted by a base station, or the like are received by the radio unit 11, and are signal-processed by the radio processing unit 13; then, the processed signals are transferred to the CPU 15.

The CPU 15 controls the operation of the mobile station. The CPU 15 performs the processing when the movement speed estimation and movement direction estimation of the mobile station, the prediction of outside-communication-area-time, the estimation of which cell is a destination cell, and the estimation of reachability are carried out by the mobile station.

In the case in which the outside-communication-area-time is predicted by the base station device 20, the mobile station 10 may further include a time information obtaining function for obtaining the predicted time information. For example, in order to obtain the time information, the mobile station 10 may transmit a signal to the base station 20 requesting the time information. Alternatively, even if the mobile station 10 is simply in a standby status, the predicted time information may be transmitted from the base station 20. The mobile station 10 may use the time information received from the base station directly as the outside-communication-area-time. If the mobile station 10 is capable of estimating the movement speed and the movement direction, or of predicting the outside-communication-area-time, the mobile station 10 may re-predict the outside communication area time on the basis of the time information transmitted from the base station 20.

The mobile station 10 includes an operation mode setting function. This operation mode setting function is related to the power supply management of the mobile station 10, and is responsible for switching between the normal power supply mode and the low power consumption mode. The setting of the operation modes is also carried out by the processing of the CPU 15. When the mobile station 10 is set to the low power consumption mode, the timer 17 is set to the predicted outside-communication-area-time of the mobile station 10, and then the mobile station 10 is set to the low power consumption mode. Due to this setting, the mobile station 10 is set to the low power consumption mode until the time set to the timer 17 is up. When the time set to the timer 17 is up, the low power consumption mode is cancelled, and the mobile station 10 is switched to the normal operation mode. Even if it is before the time set to the timer 17 is up, the low power consumption mode is cancelled when a user operates the mobile station 10.

As a specific example of the low power consumption mode, it is possible to set one or all of the radio units 11 and 12, the radio processing unit 13, and human interface unit 14 to the sleep mode. At the same time, it is possible to set most of the CPU 15 to the sleep mode by limiting the parts of the CPU 15 to be supplied with power, and it is also possible to set the entirety of the CPU 15 to the sleep mode. If the radio unit 12 and/or the radio processing unit 13 is/are set to the sleep mode, the mobile station 10 does not perform a base station search. Accordingly, it is possible to terminate a base station search for a certain length of time by setting the mobile station 10 to the low power consumption mode in which the radio unit or the like is set to the sleep mode.

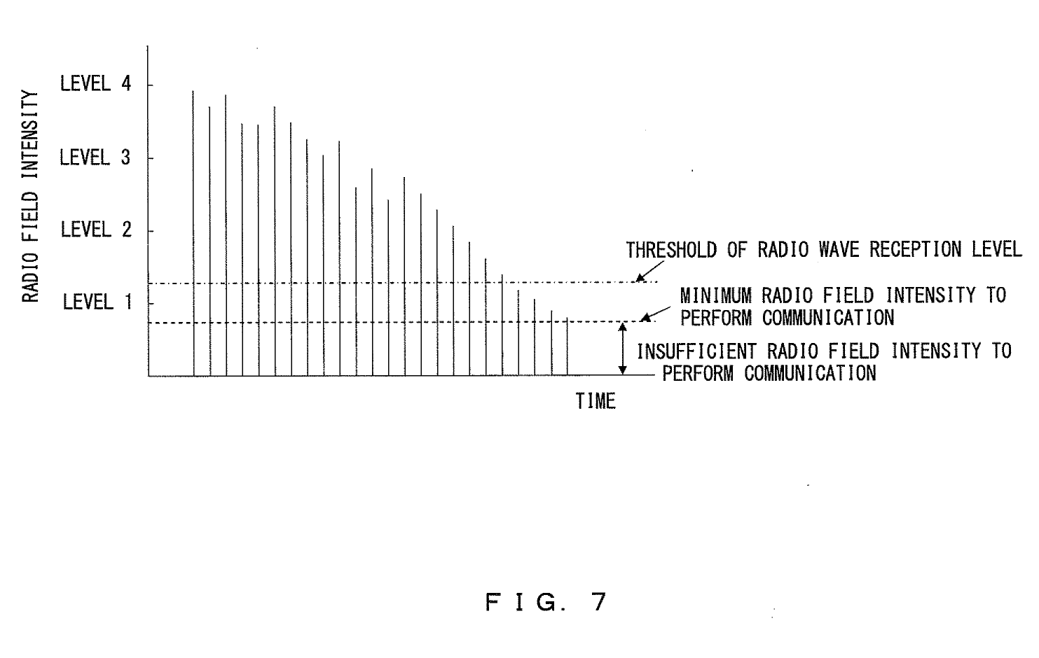

The mobile station 10 includes a measuring function for measuring the intensity of the received radio wave. The measurement of the received radio wave intensity is carried out after the radio wave received via the antenna is amplified and before the received radio wave is demodulated. In particular, the radio unit 11 or the radio processing unit 13 measures the received radio wave intensity. As illustrated in FIG. 7, the status of the radio wave can be classified into several levels depending on the measured radio field intensity or the average value of the values obtained from several measurements.

The mobile station 10 further includes a comparing function for comparing the measured radio field intensity with a specified “threshold of radio wave reception level”. If the measured radio field intensity is below the threshold of radio wave reception level, the mobile station 10 can determine that the mobile station 10 is getting close to the outside communication area.

Furthermore, when the measured radio field intensity is below the threshold of a radio wave reception level, the mobile station 10 may include an inquiring function for making an inquiry about the outside-communication-area-time to the base station. Although the threshold of a radio wave reception level can be set to an arbitrary radio field intensity, it is preferably set higher than the minimum radio field intensity to perform communications such that the inquiring function can operate, as illustrated in FIG. 7. In this case, the mobile station 10 can receive the outside-communication-area-time transmitted from the base station 20 after making the inquiry to the base station 20. The mobile station may also be configured to make the inquiry depending on the status of the radio wave classified according to the radio field intensity; for example, the mobile station may be configured to make the inquiry when the status of the radio wave becomes level 1.

It is assumed that the mobile station 10 according to the embodiment will be implemented as a mobile phone station or the like. However, it is not limited to the mobile phone station, but may be a different type of terminal device such as a Personal Digital Assistant (PDA) or a Personal Handy-phone System (PHS) for medical use.

### <Predicting Method of Outside Communication Area Time>

{Summary of Predicting Method of Outside-Communication-Area-Time}

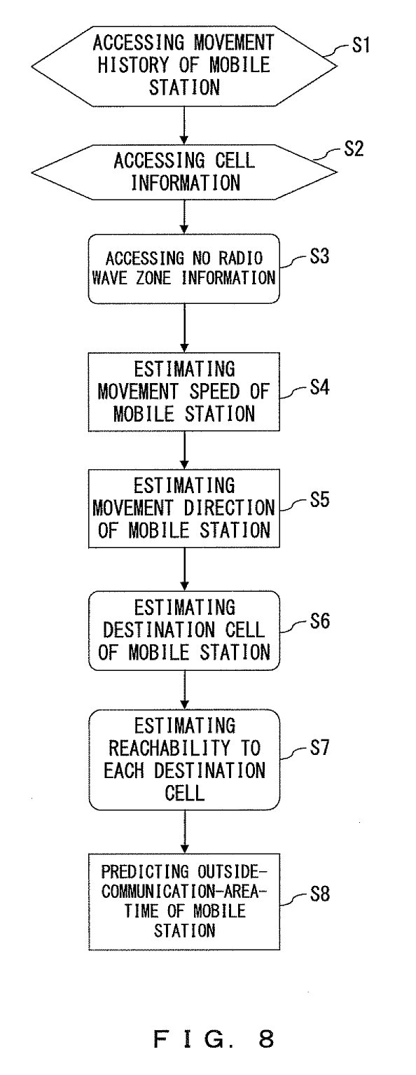

FIG. 8 is a diagram illustrating a predicting method of the outside-communication-area-time. Firstly, in steps S1-S3, the data to predict the outside-communication-area-time such as the movement history of a mobile station or cell information are accessed. Next, in steps S4-S8, the movement speed, the movement direction or the like of the mobile station is estimated on the basis of the obtained data, and then the outside-communication-area-time is predicted. Here, the order of accessing the data for the prediction is variable. That is, the execution order of steps S1-S3 is arbitrary. Moreover, in FIG. 8, the movement direction of the mobile station is predicted after the movement speed of the mobile station is predicted, but this order can be the other way round. That is, the order of steps S4 and S5 (or steps S4-S7) can arbitrarily be changed. Furthermore, as described in the above, the prediction of the outside-communication-area-time may be carried out by one of or both of the base station 20 and the mobile station 10.

{Data for Predicting Outside-Communication-Area-Data}

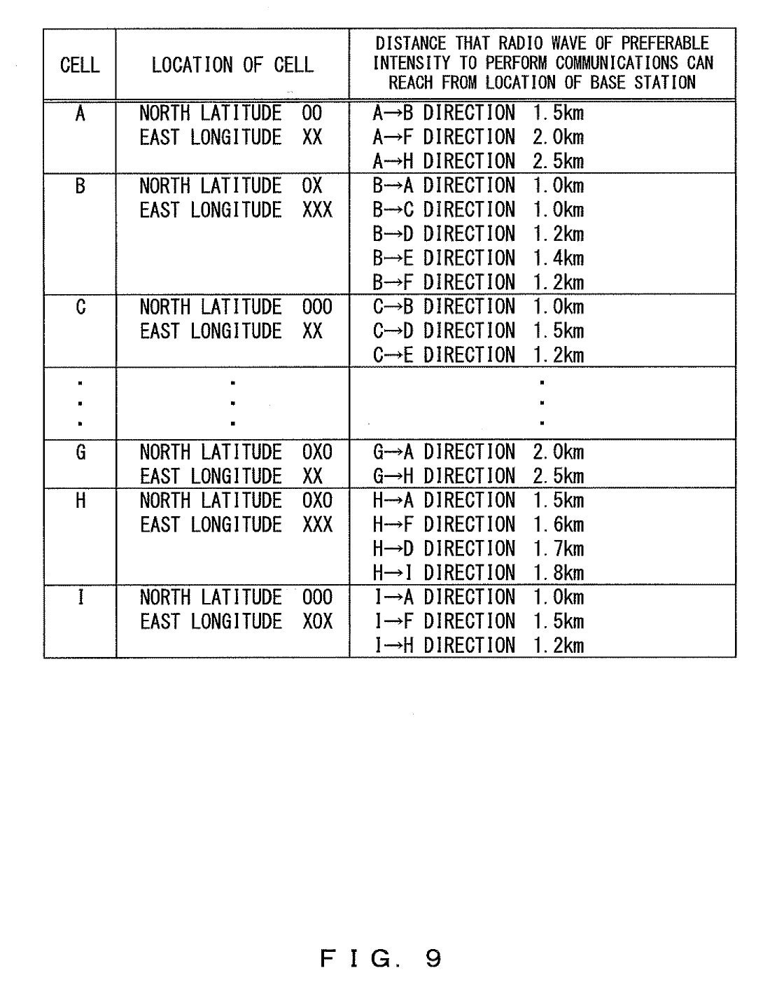

Firstly, the data for predicting the outside-communication-area-time and the location where the data is stored will be described. In the cell information database 43, the information of each cell including the location of the base stations that provides cells, and the distance that the radio wave from the base station 20 can reach are registered. FIG. 9 illustrates an exemplary cell information database 43. The distance that the radio wave from the base station 20 can reach indicates, for example, the distance that the radio wave of the preferable intensity to perform communications in the direction of an adjacent or peripheral cell can reach from the base station. The distance that the radio wave of the preferable intensity to perform communications can reach from a specific base station is recorded as the distance that the radio wave of the preferable intensity to perform communications can reach from the specific base station in a straight line connecting the base station of the specific base station and the base station forming the adjacent or peripheral cell. Moreover, the cell information database 43 may include different information such as the distance between one particular base station and its peripheral base stations.

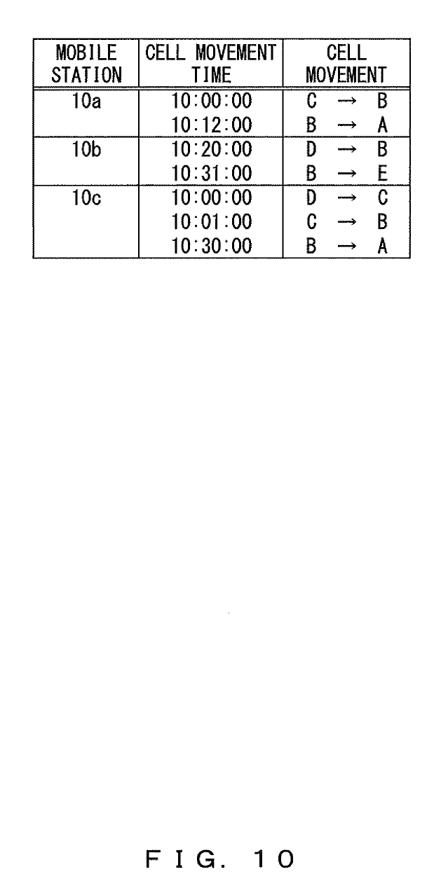

In the movement history information database 42, the time at which the mobile station moved between cells, and the information as to from what cell to what cell the mobile station moved are recoded for every mobile station. An example is illustrated in FIG. 10. The movement history information database 42 may include different information such as the movement direction of a mobile station at the time when the mobile station moved between cells.

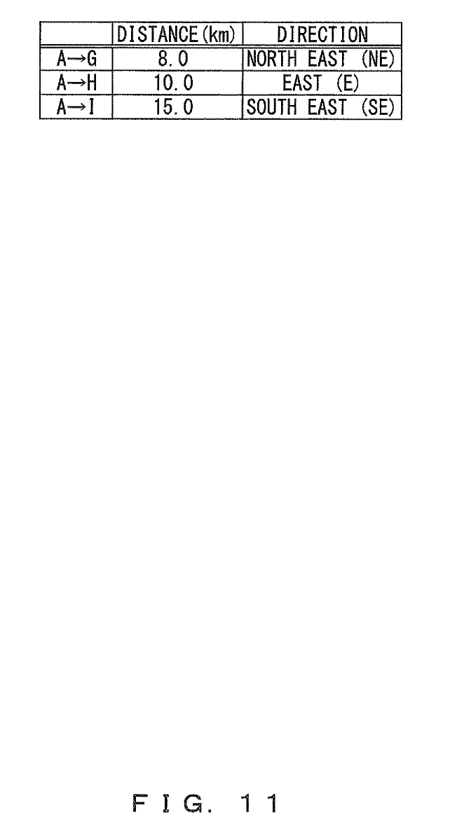

In the no radio wave zone information database 44, the information of the zone where the radio wave of the preferable intensity to perform communications does not reach from a base station is registered. More specifically, it is the database including the information of a movement source cell located at an edge of the communication area, a movement destination cell separated from the movement source cell by the distance of a no radio wave zone, and the length and direction of the no radio wave zone from the movement source cell and the movement destination cell. An exemplary no radio wave zone information database 44 is illustrated in FIG. 11.

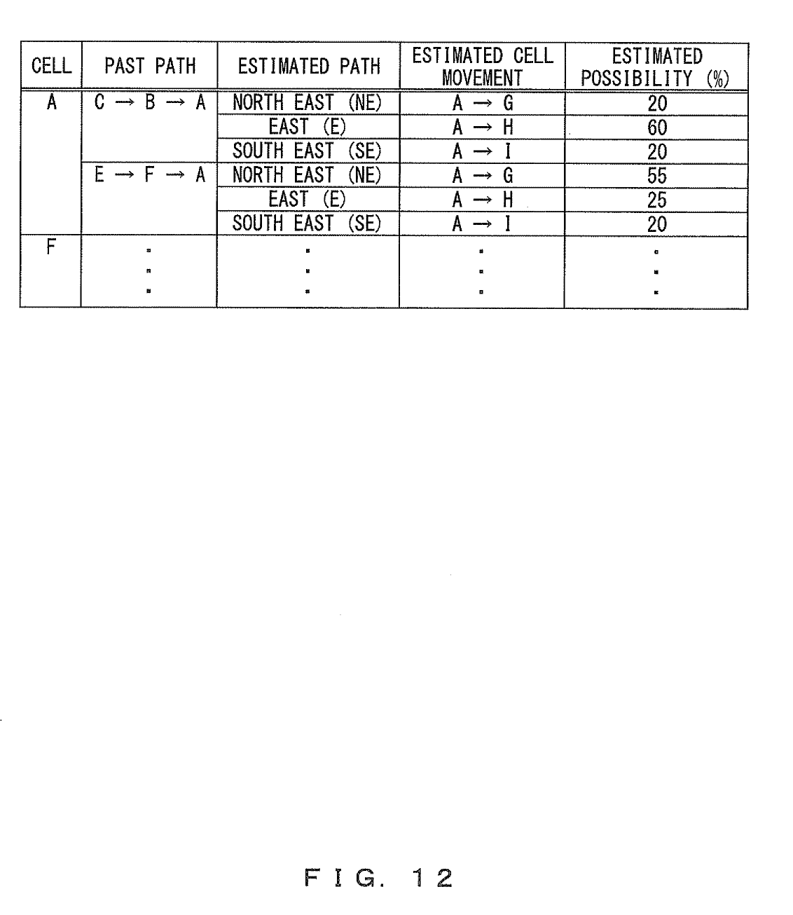

In order to estimate the movement direction, the movement direction estimation table 45 is used. FIG. 12 illustrates an exemplary movement direction estimation table 45. In the movement direction estimation table 45, the past movement path of a mobile station and the estimated future path of the mobile station are recorded for every base station located at an edge of the communication area. Moreover, as illustrated in FIG. 12, when two or more directions are estimated, the movement direction estimation table 45 includes the information of the estimated possibility indicating the possibility that the mobile station will move to the respective directions. It is also possible for certain destination cells to be preliminarily specified for each of the directions predicted as a movement direction, and for the resultant information to be recorded in the movement direction estimation table 45. The data in the movement direction estimation table 45 is determined on the basis of the empirical rule or the like. More specifically, the path of a mobile station is estimated on the basis of a map, a marine chart or the like. The movement direction of a mobile station is estimated for every base station located at an edge of the communication area, on the basis of road construction status, the amount of traffic in the vicinity of the road construction, possible paths to a relatively large city, the existence of facilities such as a seaport, or the like, and the resultant information is recorded therein. Although the estimated possibility is indicated in percentage, it is only for the purpose of simplification such that the present embodiment will easily be understood. Therefore, FIG. 12 does not indicate that the mobile station always moves in one of the directions listed in the movement direction estimation table 45.

The movement history information database 42, the cell information database 43, the no radio wave zone information database 44, and the movement direction estimation table 45 are typically provided for the switchboard 40, but all of or a part of those databases may be placed in the base station control device 30 and/or base station 20.

### {Speed Estimation of Mobile Station}

A method of estimating the speed of a mobile station will be described in detail. Firstly, for one of the cells that a mobile station passed through, the distance that the mobile station passed through in a condition of being able to communicate is determined. Here, the straight line connecting the base stations of cells existing before and after the object cell for which the distance that the mobile station passed through in a condition of being able to communicate is obtained and the straight line is considered to approximate the path of the mobile station. For example, supposing that the mobile station moved as illustrated in FIG. 5, it is approximated that the mobile station moved along the straight line connecting the base station of cell C and the base station of cell A, in order to determine the distance in cell B through which the mobile station passed in a condition of being able to communicate. Accordingly, the distance through which the mobile station was able to communicate in cell B is the sum of the distance that the radio wave of the preferable intensity to perform communications can reach in the B-IA direction and the distance that the radio wave of the preferable intensity to perform communications can reach in the B→C direction. The distance that the radio wave of the preferable intensity to perform communications can reach from the base stations can be obtained, as described in the above, by accessing the cell information database 43 that is illustrated in FIG. 9.

Next, regarding the cell for which the distance through which the mobile station passed in a condition of being able to communicate was determined, the length of time during which the mobile station was able to communicate is determined. The length of time during which the mobile station was able to communicate in the cell for which the distance is determined is between the time when the mobile station moved into the cell and the time when the mobile station moved out of the cell. This length of time can be determined from the movement history information that is listed in FIG. 10. In the example of a mobile station 10a of FIG. 10, the length of time that the mobile station 10a was able to communicate in cell B is 12 minutes, i.e., from the time when the mobile station 10a moved from cell C to cell B and the time when the mobile station 10a moved out of cell B.

The movement speed of the mobile station can be calculated from the distance through which the mobile station was able to communicate in a certain cell and the length of time spent to move through that cell. In the example of a mobile station 10a, it is calculated that the mobile station 10a moved at 10 km/h as the mobile station 10a moved across a distance of 2 km in which it was able to communicate (according to cell area information in FIG. 9) in cell B in 12 minutes.

It is also possible to estimate the movement speed by calculating the length of time spent to move across two arbitrary base stations from the movement history of the mobile station. For example, as the mobile station 10a moves in the order of cell C, cell B, and cell A, it is approximated that the mobile station moved in the straight line connecting the base station of cell C (base station C) and the base station of cell B (base station B) when the mobile station 10a moves from cell C to cell B. The distance between the base station C and base station B is calculated from the locations of both base stations. Here, if the distances between the base stations existing in the periphery are preliminarily measured and stored in a database, the distance information may be obtained by accessing that database. Preferably, the information of the distances between the base stations is included in the cell information database 43. Next, the length of time spent to move across the two base stations is determined. In this determination, the time at which the mobile station moved through the base stations is assumed to be in the middle of the time that the mobile station existed in the cells configured by the base stations. For example, the time at which the mobile station 10a of FIG. 10 passed through is assumed to be 10:06. Further, the length of time assumed to be spent to move across the base stations is calculated from the time at which the mobile station moved through the base stations. The speed of the mobile station is calculated by dividing the distance between the base stations by the calculated length of time assumed to be spent to move across the base stations. This way of estimating is effective even when the distance of moving through specific cells is difficult to calculate from the cell information, for example when the mobile station moved from the base station of cell D directly to the base station of cell F in FIG. 5.

Furthermore, in a mobile station having the Global Positioning System (GPS) function, the data obtained by the GPS function may be used for estimating the distance and movement speed.

{Estimation of Movement Direction of Mobile Station}

The movement direction of a mobile station is estimated on the basis of a movement direction estimation table as illustrated in FIG. 12. Firstly, the movement history information database 42 or the home location register 41 are referred to, and the cell at which the mobile station is located is specified. Next, the cell information database 43 is referred to, and thereby it is confirmed that the cell at which the mobile station is located is in the vicinity of outside the communication area. Further, the past path through which the mobile station passed is specified from the information included in the movement history information database 42. On the basis of the obtained information, the movement direction estimation table 45 is referred to, and thereby the future path is estimated from the past path of the mobile station. Here, two or more directions may be estimated as the movement direction. If two or more directions are estimated, the possibility of moving towards each of the directions is specified from the data recorded on the movement direction estimation table 45.

For example, the case is described in which the mobile station 10a moves from cell C to cell A through cell B and moves even further. The movement direction estimation table 45 (FIG. 12) is referred to on the basis of the past path of the mobile station 10a, and for the case in which the mobile station moves outside the communication area, the possibility of moving northeast, east, or southeast is estimated. At the same time, the probability that the mobile station will move northeast:east:southeast is respectively specified as 20%:60%:20%.

{Estimation of Which Cell is Destination Cell}

Which cell is a destination cell is also estimated by accessing the movement direction estimation table (FIG. 12). To access the movement direction estimation table, the movement direction of the mobile station and the data of the cell at which the mobile station is located, which are estimated by the above-mentioned methods, are used. A single cell or two or more cells may be estimated to be the movement destination.

For example, in the above-described case of the mobile station 10a, the mobile station is located at cell A, and the estimated directions are northeast, east, and southeast. On the basis of those pieces of obtained information, the movement direction estimation table is accessed. Accordingly, cell G, cell H, and cell I are estimated to be the destination cells as illustrated in FIG. 5.

{Estimation of Reachability to Destination Cell}

The estimation of reachability is carried out when two or more destination cells are estimated by the destination cell estimation function. The reachability is estimated by accessing the movement direction estimation table (FIG. 12) using the information of the cells estimated to be the destination cells, the base station at which the mobile station is located, and the movement history of the specified mobile station. The estimated possibility in the movement direction estimation table is extracted as the possibility of arriving at each of the estimated cells.

For example, in the above-described case of the mobile station 10a, it is estimated that the mobile station is located at cell A and that the destination cells are cell G, cell H, and cell I. The movement history of this mobile station is C→B→A. Accordingly, the reachabilities for cell G:cell H:cell I are respectively 20%:60%:20%.

{Prediction of Outside-Communication-Area-Time}

After the movement speed and movement direction of the mobile station are estimated, the outside-communication-area-time of the mobile station is predicted by using each of the estimation results. Firstly, on the basis of the estimated movement direction and cell information, the zone that the radio wave of the preferable intensity to perform communications does not reach in the predicted movement path is identified. Regarding the zone that the radio wave of the preferable intensity to perform communications does not reach, the outside-communication-area-time is calculated under the assumption that the mobile station moves at the same speed as the movement speed in the communication area. In other words, the outside-communication-area-time is calculated by dividing the distance of the zone that the radio wave of the preferable intensity to perform communications does not reach by the movement speed of the mobile station.

When identifying the distance of the zone that the radio wave of the preferable intensity to perform communications does not reach, no radio wave zone information database as illustrated in FIG. 11 may be used. The identification of the zone that the radio wave of the preferable intensity to perform communications does not reach on the basis of the no radio wave zone information database is carried out by using the information of the location of the base station adjacent to the outside communication area, and the predicted movement direction.

When estimating which cell is a destination cell, a specific destination cell is estimated. The distance of the zone that the radio wave of the preferable intensity to perform communications does not reach is calculated from the information of the cell at which the mobile station is located and the cell information of the estimated destination cell. More specifically, the following steps of processing are carried out. Firstly, which cell is the destination cell is estimated, and the distance between the base station of the estimated destination cell and the base station of the movement source cell is determined. Next, the distance that the radio wave of the preferable intensity to perform communications can reach from the base stations of the respective movement source and destination cell is subtracted from the obtained value. The obtained value of distance is assumed to correspond to the distance through which the radio wave of the preferable intensity to perform communications does not reach, and thus is assumed to correspond to the movement distance in the outside communication area. Here, the movement distance in the outside communication area may be obtained by accessing the no radio wave zone information database as described in the above. The mobile station is assumed to move through the obtained movement distance in the outside communication area at the predicted movement speed, and thereby the length of time for existing outside the communication area is calculated. The calculated length of time is assumed to be the outside-communication-area-time.

If two or more movement directions are estimated as the movement direction of the mobile station, the distance of the zone that the radio wave of the preferable intensity to perform communications does not reach is specified in the paths estimated for the respective predicted directions. Further, the length of time that the mobile station spent to move across each of the predicted zones that the radio wave of the preferable intensity to perform communications does not reach at the estimated movement speed is calculated. The outside-communication-area-time is predicted by using the calculated length of time and the estimated possibility of moving towards each of the directions.

For example, it is specified, as described in the above, that the mobile station 10a moves northeast (P_{NE}): east (P_{E}): southeast (P_{SE}) in the probability of 20%:60%:20%, respectively. Accordingly, the distance of the zone that the radio wave of the preferable intensity to perform communications does not reach is specified for each of the paths. Here, the zones in which the mobile station moves 8.0 km northeast, 10.0 km east, or 15.0 km southeast may be specified as the zone that the radio wave of the preferable intensity to perform communications does not reach by accessing the no radio wave zone information database (FIG. 11). Then, as the mobile station 10a is estimated to move at 10 km/h, as described above, the length of time taken for moving in each of the directions across the zone that the radio wave of the preferable intensity to perform communications does not reach is 0.8 hour, 1.0 hour, and 1.5 hours for the respective directions of northeast (T_{NE}), east (T_{E}), and southeast (T_{SE}). On the basis of these values and the possibility of moving in each of the directions, the outside-communication-area-time is calculated by the following equation:

(Outside-Communication-Area-Time)=T_{NE}*P_{NE}+T_{E}*P_{E}+T_{SE}*P_{SE}=1.06 (hours)

When a destination cell or reachability is estimated, the outside-communication-area-time is predicted by executing a similar calculation on the basis of the possibility of reaching the predicted cells and the length of time for moving across the zone that the radio wave of the preferable intensity to perform communications does not reach.

As described in the above, the mobile station 10a has the possibility of moving to cell G, cell H, and cell I, and the reachabilities for the respective cells G (P_{G}): cell H (P_{H}): cell I (P_{I}) are estimated as 20%:60%:20%. Firstly, the distance of the zone that the radio wave of the preferable intensity to perform communications does not reach during which the mobile station moves to the respective cells is specified. Again, the distance is determined by the calculation executed by the base station and/or the mobile station, or by accessing the no radio wave zone information database (FIG. 11). Thereby, the zones in which the mobile station moves 8.0 km towards cell G, 10.0 km towards cell H, or 15.0 km towards cell I may be specified as the zone that the radio wave of the preferable intensity to perform communications does not reach. When the mobile station 10a moves at 10 km/h, the length of time for passing the specified zone in the case of moving towards cell G (T_{G}), cell H (T_{H}), and cell I (T_{I}) is 0.8 hour, 1.0 hour, and 1.5 hours, respectively. Accordingly, the outside-communication-area-time can be determined by the following equation:

(Outside-Communication-Area-Time)=T_{G}*P_{G}+T_{H}*P_{H}+T_{I}*P_{I}=1.06 (hours)<

### <Operation of Power Control System>

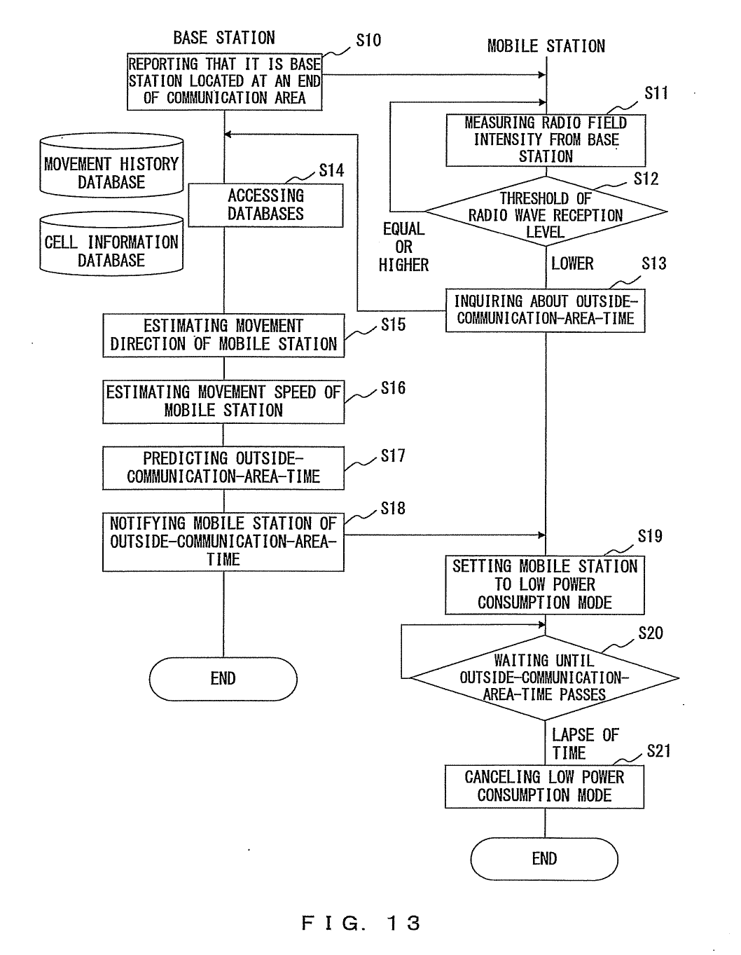

An exemplary power control system according to one embodiment is illustrated as a flow chart in FIG. 13. An example case in which all kinds of databases are located under the switchboard and the outside-communication-area-time is predicted by the base station device is illustrated in FIG. 13. Moreover, a notification function is provided by a base station of this example for notifying the mobile station that the base station device is a base station located at an end of the communication area. In this example, the mobile station is provided with an inquiring function for making an inquiry to the base station about the outside-communication-area-time. Moreover, in the flow chart of FIG. 13, the destination cell estimation function and the reachability estimation function as described in FIG. 8 is not depicted. If these processes are to be included in FIG. 13, they would be performed in step 15, the step of estimating the direction.

The flow chart will be described with the assumption that the mobile station 10a moves along the path illustrated in FIG. 5. In the flow chart, steps S10 and S14-S18 are operated by the base station, and steps S11-13 and S19-S21 are operated by the mobile station.

(1) In step S10, the base station device (base station A) providing cell A notifies the mobile station that the base station A locates at an end of the communication area. This notification is not especially limited, but for example, it may be configured such that the notification is broadcast together with an annunciation signal.

(2) In steps S11-S12, the mobile station 10a measures the radio field intensity from the base station A, and compares the measured radio field intensity with a specified threshold of radio wave reception level. This threshold of radio wave reception level is higher than a minimum value for communication between the mobile station and the base station by a specified level. Then, it proceeds to step S13 when the radio field intensity from the base station A becomes lower than the threshold of radio wave reception level.

(3) In step S13, the mobile station makes an inquiry to the base station A about the outside-communication-area-time.

(4) In step S14, once an inquiry from the mobile station 10a is received, the base station A accesses a cell information database, the movement history information database, or the like.

(5) In step S15, the direction towards which the mobile station 10a may move is estimated by accessing the movement direction estimation table. Here, a specific destination cell and its reachability are also estimated if the base station has the destination cell estimation function and the reachability estimation function.

(6) In step S16, the movement speed of when the mobile station 10a moves from cell C to cell A through cell B is calculated. On the basis of the calculated value, the future movement speed of the mobile station 10a is estimated.

(7) In step S17, the outside-communication-area-time is predicted from the results obtained in steps S15 and S16.

(8) In step S18, the base station A notifies the mobile station 10a of the predicted outside-communication-area-time.

(9) In steps S19-S20, the timer is set to the notified outside-communication-area-time, and the mobile terminal is set to the low power consumption mode. Subsequently, the mobile station 10 will be in the low power consumption mode until the time set to the timer expires. However, the mobile station 10 can be set from the low power consumption mode to the normal operation mode by an operation of the user even before the time set to the timer expires.

(10) In step S21, when the time set to the timer expires and the mobile station 10a moves into the area in which communications can be performed, the low power consumption mode is cancelled. Once an advertisement from a base station that can be communicated with is received, the mobile station 10a registers the location in response to the advertisement and maintains the able to communicate status.

As described above, according to a power control system of the embodiments, an outside-communication-area-time is predicted when a mobile station moves from the communication area to the no radio wave zone. Then, the mobile station is set to the low power consumption mode until the predicted length of time passes. Accordingly, wasted power consumption in the no radio wave zone can be avoided.

In the above embodiments, a configuration is described in which the outside-communication-area-time is calculated in the base station and the obtained value is reported to the mobile station. However, it may be configured such that the outside-communication-area-time is calculated in the mobile station.

Moreover, in the above embodiments, a configuration is described in which the mobile station operates in the low power consumption mode during the calculated outside-communication-area-time; however, the present invention is not limited to this configuration. In other words, for example, it may be configured such that the operation mode will be back to the normal operation mode shortly before the outside-communication-area-time passes.

Furthermore, the low power consumption mode is not only for setting a certain region of the mobile station to a sleeping status, but may be configured, for example, to decrease the frequency of a base station search.

As described above, in each of the above-mentioned embodiments, an outside-communication-area-time is predicted. Here, the outside-communication-area-time is time taken for the mobile station to pass through a zone in which an intensity of a received radio wave from a base station detected in the mobile station is smaller than a specified value. This zone is a non-communication area in which the mobile station does not communicate with any base station. Moreover, the operation mode of the mobile station sets the mobile station to a low power consumption mode until the outside-communication-area-time passes (i.e., the length of time estimated to be taken for the mobile station to pass through the non-communication area). Accordingly, unnecessary power consumption of the mobile station can be avoided.

Therefore, by applying the embodiments, the operable time of a mobile station can be extended by avoiding unnecessary power consumption of the mobile station in non-communication areas.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has (have) been described in detail, it should be understood that the various changes, substitutions, and alterations could be made hereto without departing from the spirit and scope of the invention.

What is claimed is:

1. A power control system for controlling power consumption of a mobile station used in a radio communication system, comprising:
a prediction unit configured to predict an outside-communication-area-time taken for the mobile station to pass through a zone in which an intensity of a received radio wave from a base station detected in the mobile station is smaller than a specified value, on a basis of cell information indicating a location of the base station and a communication area, and movement history information indicating movement history of the mobile station; and
an operation mode setting unit configured to set the mobile station to a low power consumption mode during the outside-communication-area-time obtained by the prediction unit.

2. The power control system according to claim 1, wherein the operation mode setting unit stops a base station search until the outside-communication-area-time passes.

3. A computer readable storage medium stores a program for providing a computer with a function, the function comprising:
estimating movement speed of a mobile station on a basis of cell information indicating a location of base stations and a communication area and movement history information indicating movement history of the mobile station;
estimating movement direction of the mobile station on a basis of the movement history information; and
predicting a length of time taken for the mobile station to pass through a zone in which an intensity of a received radio wave from a base station detected in the mobile station is smaller than a specified value as a length of time for operating the mobile station in a low power consumption mode, on a basis of the estimated movement speed of the mobile station, the estimated movement direction of the mobile station, and the cell information.

4. A base station device, comprising:
a speed estimation unit configured to estimate a movement speed of a mobile station, on a basis of cell information indicating a location of base stations and a communication area, and movement history information indicating movement history of the mobile station;
a direction estimation unit configured to estimate a movement direction of the mobile station on a basis of the movement history information; and
a prediction unit configured to predict an outside-communication-area-time taken for the mobile station to pass through a zone in which an intensity of a received radio wave from a base station detected in the mobile station is smaller than a specified value as a length of time for operating the mobile station in a low power consumption mode, on a basis of the movement speed, the movement direction, and the cell information.

5. The base station device according to claim 4, further comprising
a destination cell estimation unit configured to estimate which cell is a destination cell of the mobile station on a basis of the movement direction of the mobile station obtained by the direction estimation unit,
wherein
the prediction unit calculates the outside-communication-area-time on a basis of the movement speed of the mobile station obtained by the speed estimation unit, and a distance to the destination cell.

6. The base station device according to claim 4, further comprising
a notification unit configured to notify the mobile station of the outside-communication-area-time.

7. The base station device according to claim 5, further comprising
a reachability estimation unit configured to estimate reachability to each of the destination cells when the plurality of destination cells are estimated to be destinations by the destination cell estimation unit,
wherein
the prediction unit calculates the outside-communication-area-time on a basis of a length of time taken for moving to the destination cells and the reachability.

8. A mobile station, comprising:
a measurement unit configured to measure an intensity of a received radio wave from a base station;
an obtainment unit configured to obtain time information indicating an outside-communication-area-time taken for the mobile station to pass through a zone in which a measurement value by the measurement unit is smaller than a specified value, and predicted on a basis of cell information indicating a location of base stations and a communication area and movement history information indicating movement history of the mobile station; and
an operation mode setting unit configured to set an operation mode of the mobile station to a low power consumption mode during a certain length of time corresponding to the time information obtained by the obtainment unit.

9. The mobile station according to claim 8, wherein
the operation mode setting unit stops a base station search until the certain length of time passes.

10. The mobile station according to claim 8, further comprising
an inquiry unit configured to make an inquiry to the base station about the outside-communication-area-time when radio field intensity measured by the measurement unit is weaker than a specified radio field intensity.
